(19) United States
(12) Patent Application Publication
(10) Pub. No.: US 2006/0256649 A1
(43) Pub. Date: Nov. 16, 2006

(54) Method and apparatus for mixing fluids for particle agglomeration

(75) Inventors: Rodney John Truce, Sherwood, Queensland (AU); John Walter Wilkins, Camp Hill (AU)

Correspondence Address: THE WEBB LAW FIRM, P.C., 700 KOPPERS BUILDING, 436 SEVENTH AVENUE, PITTSBURGH, PA, 15219, US

(73) Assignee: INDIGO TECHNOLOGIES GROUP PTY LTD., Queensland (AU)

(21) Appl. No.: 10/554,825

(22) PCT Filed: Apr. 28, 2004
(86) PCT No.: PCT/AU04/00546

§ 371 Date: Oct. 27, 2005

(30) Foreign Application Priority Data
Apr. 28, 2003 (AU) 2003902014
Feb. 9, 2004 (AU) 2004900593

(51) Int. Cl. B01F 5/06

(52) U.S. Cl. 366/337

(57) ABSTRACT

An aerodynamic agglomerator (10) promotes mixing and agglomeration of pollutant particles in a gas stream, to facilitate the subsequent removal of the particles from the gas stream. The agglomerator (10) is mounted in a duct (11) through which the gas stream flows. The agglomerator (10) comprises a plurality of parallel plates (12) which extend in the overall direction of flow of the gas stream, and are spaced transversely across the width of the duct (11) to divide the duct into multiple parallel passages. The duct (11) is configured and/or has formations therein for creating large scale turbulence in the gas stream upstream of the passages. A vane assembly (13) is provided in each passage for generating a zone of small scale turbulence of such size and/or intensity that the pollutant particles are entrained in the turbulence. Each vane assembly (13) is located centrally relative to its respective passage and comprises a plurality of sharp-edged vanes (15) spaced successively in the overall direction of flow of the gas stream. The large scale turbulence in the substreams causes each substream to pass through the zone of small scale turbulence in its respective passage so that particles therein are subjected to the small scale turbulence.

This invention relates generally to method and apparatus for mixing fluids for particle agglomeration. The invention is particularly, but not solely, suitable for use in pollution control to remove pollutant fine particles from air streams.

In a preferred embodiment, the invention is directed to aerodynamic particle agglomeration in which particle scale turbulence is used to promote interactions and agglomeration of the particles, and thereby facilitate subsequent filtration or other removal of the particles from the air streams.

This application claims priority from Australian patent applications nos. 2003902014 and 2004900593, the disclosures of which are incorporated herein by reference.

### BACKGROUND ART

Many industrial processes result in the emission of small hazardous particles into the atmosphere. These particles often include very fine sub-micron particles of toxic compounds. As these fine particles are able to enter the human respiratory system, they pose a significant danger to public health. The identified combination of toxicity and ease of respiration has prompted governments around the world to enact legislation for more stringent control of emission of particles less than ten microns in diameter (PM10), and particularly particles less than 2.5 microns (PM2.5).

Smaller particles in atmospheric emissions are also predominantly responsible for the adverse visual effects of air pollution. For example, in coal burning installations, stack opacity is largely determined by the fine particulate fraction of the fly ash because the light extinction coefficient peaks near the wavelength of light which is between 0.1 and 1 microns.

The importance of fine particulate control can be appreciated by consideration of the number of pollutant particles in an emission rather than the pollutant mass. In fly ash from a typical coal combustion process, pollutant particles less than 2 microns in size may amount to only 7% of the total pollutant mass, yet account for 97% of the total number of particles. A process which removes all the particles greater than 2 microns may seem efficient on the basis that it removes 93% of the pollutant mass, yet 97% of the particles remain, including the more respirable toxic particles.

Various methods have been used to remove dust and other pollutant particles from air streams. Although these methods are generally suitable for removing larger particles from air streams, they are usually much less effective in filtering out smaller particles, particularly PM2.5 particles.

Many pollution control strategies rely on contact between individual elements of specific species to promote a reaction or interaction beneficial to the subsequent removal of the pollutant concerned. For example, sorbents such as activated carbon can be injected into the polluted air stream to remove mercury (adsorption), or calcium can be injected to remove sulfur dioxide (chemisorption). Additionally, particles can be made to agglomerate into larger particles by collision/adhesion, thereby improving the collectability of the particles, or the physical characteristics of the individual particles are otherwise changed to those of an agglomerate which is easier to collect and/of filter.

However, in order for these interactions to take place, the species of interest must be brought into contact. For many industrial pollutants in standard flue ducts, this is difficult for several reasons. For example, the time frames for reaction/interaction are short (of the order of 0.5-1 second), the species of interest are spread sparsely (relative to the bulk fluid) through the exhaust gases, and the scale of the flue ducting is large compared to the scale of the pollutant particles.

Normally, exhaust gases from the outlet of an industrial process are fed into a large duct which transports them to some downstream collection device (e.g. an electrostatic precipitator, bag filter, or cyclone collector) as uniformly and with as little turbulence/energy loss as possible. Such turbulence as is generated en route is normally a large scale diversion of gases around turning vanes, around internal duct supports/stiffeners, through diffusion screens and the like. This turbulence is always of the scale of the duct and is as brief as possible to achieve the desired flow correction.

Similarly, when mixing devices are employed for a specific application, eg. sorption of a particular pollutant, they are usually devices that generate a large-scale turbulence field (i.e. of the order of the duct width or height), and are arranged as a brief curtain/s that the gases must pass through.

It is also known to use vortex generators in mixing chambers to promote mixing of fluids. Again, the known vortex mixers create large scale turbulence of the order to the dimensions of the duct or chamber.

Whether they be particulate (e.g. flyash), gaseous (e.g. SO₂), mist (e.g. NOₓ), or elemental (eg. Mercury), the pollution species which are the more difficult to collect within industrial exhaust flues are those of the order of micrometers in diameter (i.e. 10⁻⁶ metres). Due to their small size, they occupy a very small volumetric proportion of the total fluid flow. For example, one million 1 μm diameter particles would occupy less than 0.00005% of the volume of 1 cm³ of gas (assuming that the particles are spherical). Even at 10 μm diameter, this proportion only increases to 0.05%. When it is considered that a pollutant such as Mercury may only account for a few parts per million (ppm) of the total species present, it is apparent that relative to particle size, there is a significant amount of space/distance between the species being transported by an industrial flue gas. Large scale mixing, even by vortex generators, is therefore a “hit or miss” affair, and largely inefficient.

Furthermore, it is a characteristic of small particles entrained in a flowing fluid that they will follow streamlines in the fluid flow if there is insufficient force to move them out of that flow. That is, if the viscous forces of the fluid dominate the inertial forces of the particle, then the particle will follow the fluid. Known turbulent mixing regimes of the scale of the duct are many orders of magnitude larger than the particle size. When viewed from the perspective of the particle, they are far from being chaotic but rather, are relatively smooth. Whilst there may be many changes of direction for a particle in its passage through a turbulent flow in a duct or through a standard mixing region, they are all relatively long range compared to the size or scale of the particle. Consequently, particles in the stream follow more or less the same path without interaction with the particles surrounding them. At particle scale, there is relatively little mixing and consequently, the known mixing processes achieve poor efficiency in agglomeration.

Systems intended to maximise the collision rate of very small pollution species which occupy a tiny proportion of the volume of the total fluid flow should therefore impart small scale turbulence, i.e. at the scale of the particle, to have maximum effect. Particle scale turbulence will cause the minute particles to move along many different trajectories at various velocities, and thereby promote interactions and agglomeration. Unfortunately, current design philosophies do not adequately address these criteria.

It is an aim of the present invention to provide method and apparatus for mixing fluids for particle agglomeration, to achieve improved mixing or interaction of fine particles in fluid flows, either with the same species or other introduced species of larger particles, and thereby promote more efficient agglomeration of the particles or sorption by the larger particles.

### SUMMARY OF THE INVENTION

In one broad form, the present invention provides a method of promoting mixing of substances in a fluid stream, comprising the steps of

generating large scale turbulence in the fluid stream;

dividing the fluid stream into a plurality of substreams;

providing a formation in each substream to create a zone of small scale turbulence in the vicinity of the formation; and

causing each substream to pass through its respective zone of small scale turbulence so that it subjected to the small scale turbulence.

In another form, the invention provides apparatus for promoting mixing of substances in a fluid stream, comprising

a conduit for the fluid stream;

a plurality of passages in the conduit for dividing the fluid stream into substreams flowing through respective said passages;

means for generating large scale turbulence in the fluid stream upstream from the plurality of passages; and

a formation in each passage for generating a zone of small scale turbulence in the vicinity of the formation;

wherein in use, the large scale turbulence causes the substream in each passage to pass through the zone of small scale turbulence.

Each formation is preferably located centrally relative to its respective substream, and may suitably comprise a plurality of spaced vanes arranged successively in a plane extending in the overall direction of flow of the fluid stream.

The vanes should be spaced apart, yet close enough to provide a continuous zone of small scale turbulence. The vanes can be mounted in a generally planar frame positioned in a central plane of the passage and extending in the overall direction of flow of the fluid stream.

Each vane is typically an elongate member having sharp edge portions angled obliquely to the overall direction of flow of the fluid stream. The vane may optionally have a toothed edge portion.

The agglomerator may include a plurality of parallel, generally planar, members extending in the overall direction of flow of the fluid stream, and spaced transversely across the conduit. The passages are defined between adjacent pairs of the planar members. However, it is to be understood that the passages need not be formed by solid dividers, and may instead be notional passages for the respective substreams.

In one embodiment of the invention, the conduit is an air duct, the fluid stream is an exhaust gas flow from an industrial process, and the substances include pollutant particles. In this embodiment, the invention involves the use of turbulence to manipulate the position, velocity and trajectories of pollutant particles of micron or sub-micron size carried in the exhaust gas stream, to increase the probability of their colliding with each other and/or with other particles in the gas flow to agglomerate into larger, more easily removable particles, and/or to increase the probability of their colliding and interacting with a larger species of particles introduced into the gas flow for the purpose of removing the pollutant particles.

This process involves the fundamental steps of:

(i) generation of large scale turbulent flows of the appropriate scale to cause macro turbulence in the exhaust gas stream;

(ii) dividing the gas stream into substreams in respective passages; and

(iii) subjecting the substreams to small scale turbulence.

The terms “large scale turbulence” and “macro turbulence” are intended to mean turbulence on a scale of the order of the duct dimensions, i.e. turbulence whose influence extends across the entire duct.

The terms “small scale turbulence”, “micro turbulence” and “particle scale turbulence” are intended to mean turbulence on a sufficiently small scale to entrain individual particles in the turbulence, and thereby enhance aerodynamic particle agglomeration. This turbulence is normally restricted to a zone in the immediate vicinity of the vanes.

In the zone of small scale turbulence, which typically extends longitudinally along a central portion of each passage, the particles are fully entrained and subjected to turbulent flow. This turbulent flow promotes collisions and interactions between the small particles, resulting in their agglomeration.

The upstream large scale turbulence is normally caused by the geometry of the conduit itself, e.g. bends, branches, contractions and expansions. However, if there is insufficient large scale turbulence in the fluid stream where it enters the passages, additional large scale turbulence may be imparted to the fluid stream by introducing obstacles such as posts and deflectors in the conduit upstream from the passages.

When the turbulent fluid stream is divided into substreams in the respective passages, the substreams are also subject to this large scale turbulence. Consequently, the particles in each substream passes through the zone of small scale turbulence in its respective passage, and are subjected to micro turbulence, i.e. at particle scale.

The use of small scale turbulence is counterintuitive. Normally, it is desirable that the pressure drop in the gas stream be as low as possible. For this reason, known particle mixing systems normally use large scale turbulence. However, as mentioned above, these are inefficient. Small scale turbulence promotes better mixing of the particles, but results in significant pressure loss. The present invention employs small scale turbulence but only in a limited zone in each passage, thereby minimising pressure loss. The large scale turbulence in the fluid substream in each passage ensures that the particles in each substream pass through the zone and are subjected to mixing at particle scale.

The small scale turbulence may be in the form of vortices generated by sharp-edged vanes. Preferably, a multiplicity of small, low intensity vortices are used to fully entrain the individual fine particles and subject them to turbulent flow, thereby resulting in collisions and interactions between the particles, and more efficient agglomeration of the particles. Small particles can agglomerate with each other to former larger particles. Small particles can also agglomerate with larger particles in the fluid stream, The agglomerated particles are subsequently easier to remove from the gas stream using known methods.

In another embodiment, one or more species of larger particles are introduced into the gas stream for removal of the pollutant particles. When the pollutant particles contact the larger species, they tend to adhere thereto or react therewith, and can therefore be removed from the gas stream with the larger species. The fine pollutant particles are entrained in the vortices in the zone of small scale turbulence, but the larger particles in each substream are not, or are entrained to a lesser extent. The relative movement between the small and large particles results in higher frequency of collisions between them, and more efficient removal of the fine (pollutant) particles by the larger (removal) particles.

Preferably, the Stokes number of the small scale turbulent flow generated by the vortices is selected so that fine pollutant particles will be entrained, but not the larger removal species. Typically, a Stokes number much less than 1 will ensure entrainment of the fine pollutant particles. The larger removal species of particles should have a Stokes number much greater than 1 so that they are not entrained. In practical terms, the eddies or vortices generated in the gas stream are of the order of 10 mm.

The pollutant particles may be of gaseous, liquid or solid form. The larger species may be of liquid or solid form, e.g. liquid droplets.

The removal species may be a chemical, such as calcium, which reacts chemically with pollutant particles, (such as sulphur dioxide) to form a third compound (e.g. gypsum). Alternatively, the removal species of particles may remove the pollutant particles by absorption, or by adsorption (carbon particles adsorbing pollutant mercury particles), or the removal species of particles may simply remove the fine pollutants by agglomerating with the pollutants through impact adhesion.

In order that the invention may be more fully understood and put into practice, embodiments thereof will now be described, by way of example only, with reference to the accompanying drawings.

### BRIEF DESCRIPTION OF THE DRAWINGS

FIG. 1 is a plan view of a duct having an agglomerator according to one embodiment of the invention.

FIG. 2 is a plan view of the agglomerator of FIG. 1.

FIG. 3 is a schematic sectional plan view of a portion of a vane assembly of the agglomerator of FIG. 1.

FIG. 4 is a perspective view of a vane of the vane assembly of FIG. 3.

FIG. 5 is a schematic sectional plan of part of the agglomerator of FIG. 1, showing large scale turbulence.

FIG. 6 is a schematic sectional plan of a portion of a vane assembly of FIG. 3, showing regions of small scale turbulence.

FIGS. 7(a) to (e) are perspective views of alternative vanes.

### DESCRIPTION OF PREFERRED EMBODIMENTS

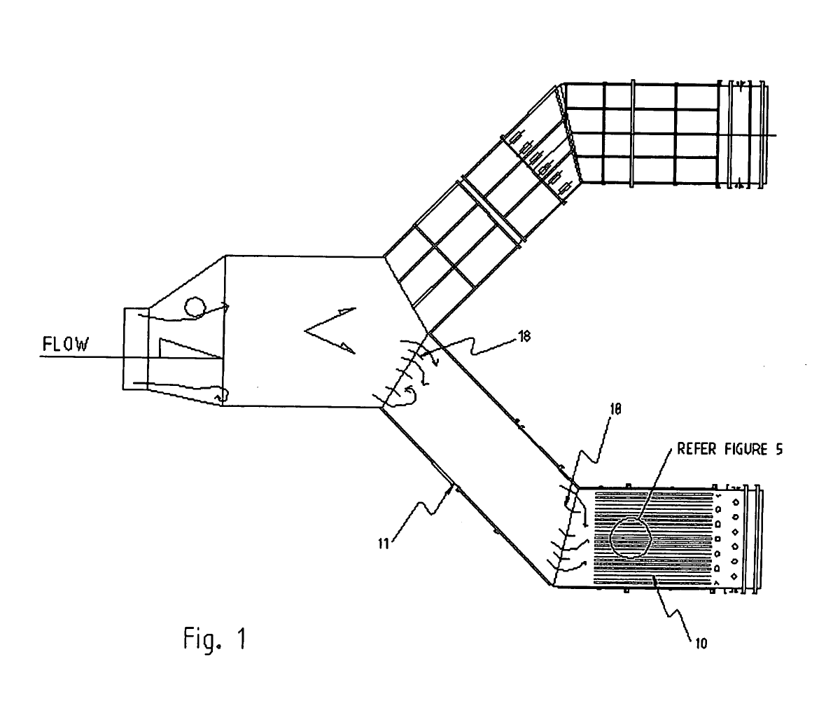

FIGS. 1 to 6 illustrate an aerodynamic agglomerator according to one embodiment of this invention. The agglomerator 10 is housed in a duct 11 which typically receives a flow of exhaust gas from an industrial process, as shown in FIG. 1.

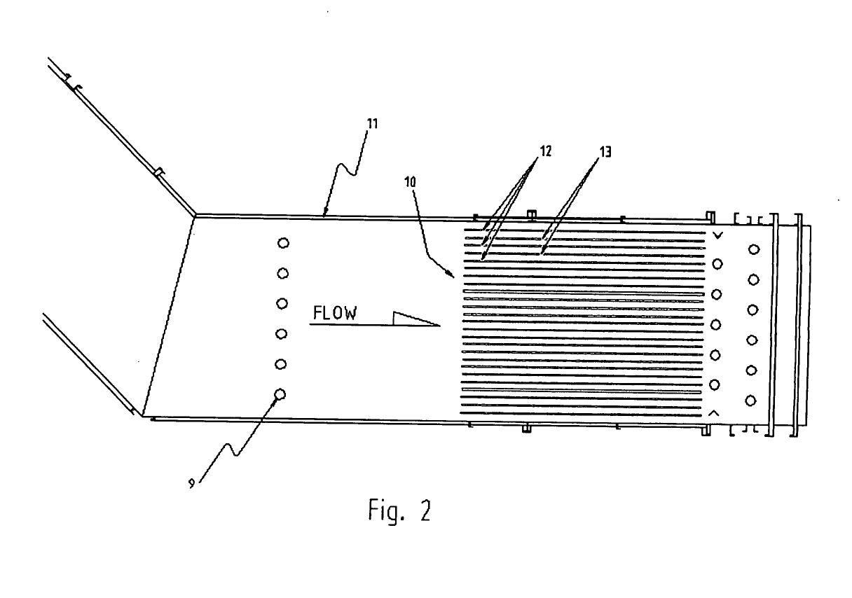

The agglomerator 10 comprises a plurality of generally planar members, such as metal plates 12, which extend longitudinally in the duct 11 (i.e. in the direction of overall gas flow), and are spaced transversely across the whole width of the duct. Passages are formed between the plates 12, and the gas flow is divided into substreams flowing through respective passages. Although the plates 12 are mounted vertically as shown in FIG. 2, they can be arranged horizontally if desired. Moreover, the plates 12 need not be solid. Perforated plates can be used if desired.

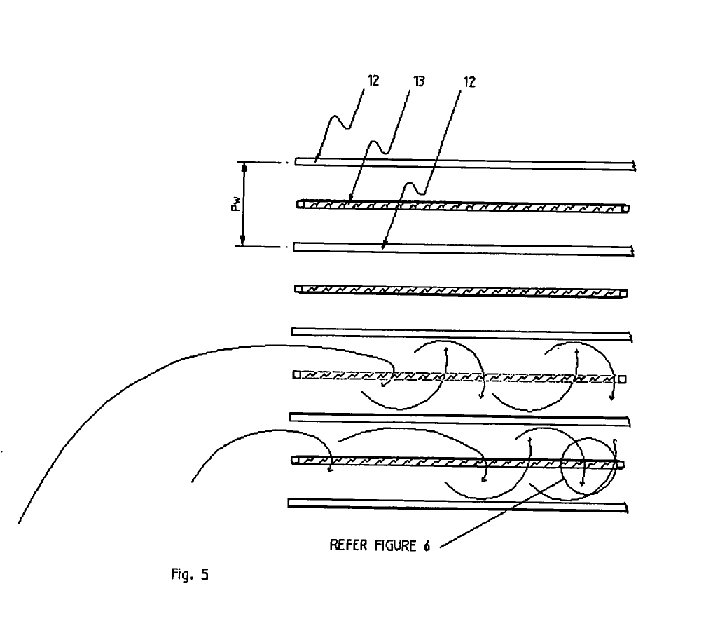

Vane assemblies 13 are mounted between the plates 12. Each vane assembly 13 is located centrally in its respective passage between two adjacent plates 12, and extends parallel to the plates 12 as shown more clearly in FIG. 5.

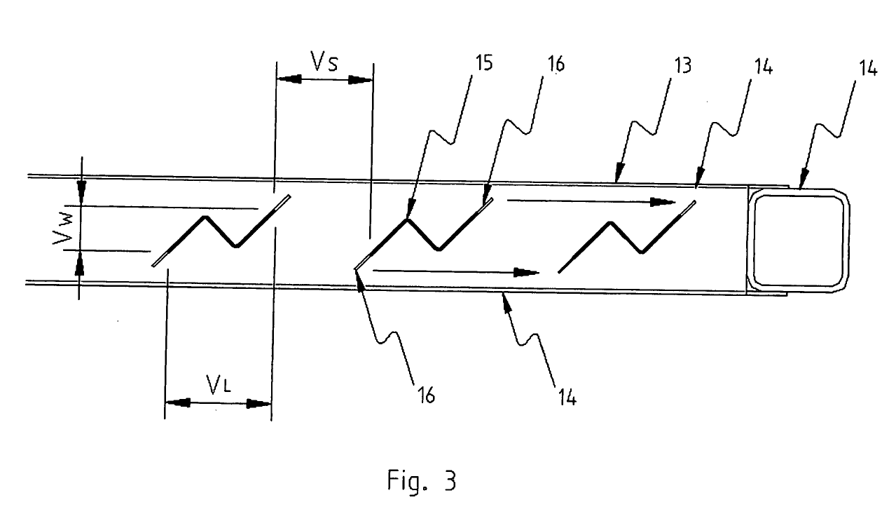

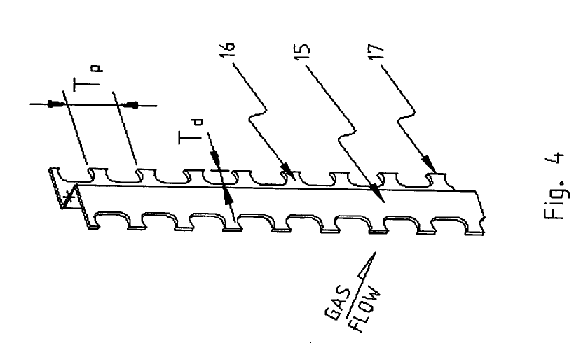

The construction of each vane assembly 13 is shown in more detail in FIGS. 3 and 4. Each vane assembly 13 comprises a generally planar rectangular frame 14 which, in use, may be suspended from the duct roof centrally in the passage between a pair of adjacent plates 12. Each frame 14 has a plurality of spaced upright vanes 15 mounted generally within the plane of the frame. Each vane 15 is typically a metal strip of “Z” section, angled to the direction of gas flow through the passage. The vertical edges 17 of each vane 15 are preferably scalloped to form teeth 16 having a depth T_{d}, and a spacing or pitch Tₚ.

The vane length V₁ is the dimension of the main body of the vane 15 in the direction of gas flow, as shown in FIG. 3. The vane spacing Vₛ is the distance between successive vanes, excluding teeth. The vane width V_{w} is the dimension of the main body of the vane 15 transverse to the gas flow. The passage width P_{w} is the internal distance or spacing between adjacent plates 12.

Sufficient plates 12 are provided to divide the full width of the duct 11 into passages, and sufficient vane assemblies 13 are provided so that a vane assembly is position centrally in each passage between adjacent plates. Typically, the passage width is around 275 mm, but passage widths may typically range from 100 mm to 750 mm, providing that the ratio of passage width P_{w} to vane width V_{w} is maintained between a minimum of 2.5 and a maximum of 25.

The vanes 15 in each frame 14 are spaced longitudinally, so that successive vanes are in the flow wake or shadow of the preceding vane. The spacing Vₛ between successive vanes 15 is roughly equivalent to the size of the flow wake generated by the leading vane. In this manner, there is overlap between the microturbulence generated by adjacent vanes, or at least a continuous region of microturbulence.

The flow wake generated by a vane 15 is proportional to the width V_{w} of the vane in the direction transverse to the gas flow, and the length V₁ of the vane in the direction parallel to the gas flow. In the illustrated embodiment, Vₛ is approximately equal to V₁. The vane spacing Vs may suitably range from 0.5 V_{w} to 8 V_{w}. Similarly, the vane length V₁ may suitably range from 0.5 V_{w} to 8 V_{w}.

If teeth are used on the vanes, the tooth depth is typically 0.25V_{w} to 2 V_{w}, and the tooth pitch is typically 0.5 V_{w} to 2 V_{w}.

It is to be noted that the agglomerator 10 is passive, i.e. the components of the agglomerator are not charged or electrified to any significant extent.

In use, the gas flow in the duct 11 will be subjected to large scale or macro turbulence. Ordinarily, the presence of expansions, contractions, bends, branches, deflectors, vanes, braces and other physical formations commonly found in industrial exhaust ducts will be sufficient to impart the large scale turbulence to the air flow. For example, deflector vanes 18 used to direct gas flow cause separation and long range turbulence in the gas flow. If however, there is insufficient macro turbulence in the gas stream when it reaches the agglomerator 10, flow disrupters can be added to the duct 11 to provide the necessary macro turbulence. For example, if there is a significant length of duct (say, equivalent to four duct diameters) immediately prior to the agglomerator 10 which is free of turbulence inducing formations, then flow disrupters should be added to the duct.

A suitable flow disrupter is an array of 100 mm diameter pipes 9 (or alternatively 100 mm×100 mm angle sections) mounted in the duct 11 so that they extend fully through the gas stream to cause large scale turbulence. Such pipes 9 should be mounted no more than 1 metre apart across the duct. It will be apparent to those skilled in the art that many different physical formations can be used upstream of the agglomerator 10 to impart macro turbulence to the gas stream if there is insufficient large scale turbulence immediately prior to the agglomerator 10.

When the gas flow passes through the agglomerator 10, it is divided into substreams which flow through respective passages between adjacent plates 13. The macro turbulence in the gas stream continues in the substreams, causing the particles in each substream to pass through the vane assembly 13 in the corresponding passage, as illustrated by the flow lines in FIG. 5. The large scale, long range turbulence in the substreams ensures that substantially all of the substream in a passage circulates through the vane assembly 13 located centrally in the passage.

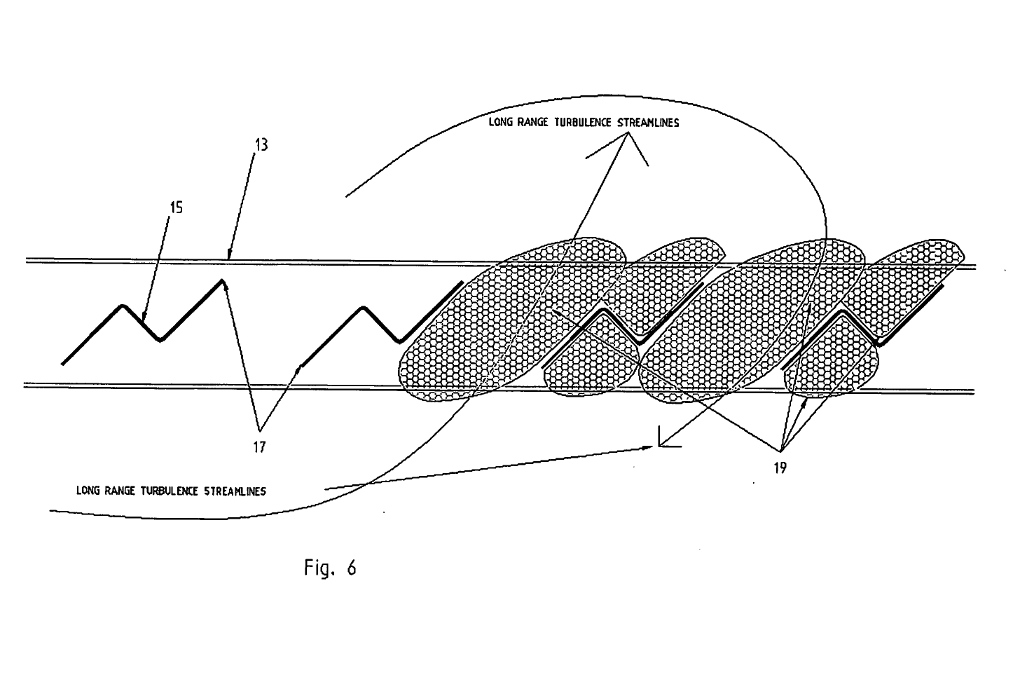

When a substream passes through a vane assembly 13, it is subjected to small scale or micro turbulence, as indicated by the shaded portions 19 in FIG. 6. The angled vanes 15 create turbulence at particle scale, promoting interactions and collisions between particles in the substream within each passage, and enhancing the agglomeration of the particles. Due to the small scale turbulence created in the vicinity of the vanes 11, particles in the substream are entrained in the turbulence, leading to significantly increased likelihood of collision and adherence. The adherence process may be a surface interaction (such as an adsorption, chemisorption or absorption process), a molecular interaction (as a result of van der Waals forces) or a wetting process (as a result of the impact of mists with other mist droplets or solid particles).

The small scale or micro turbulence may be in the nature of a plurality of small vortices, typically 10-15 mm. The angled surfaces, sharp edges and discontinuous or zigzag formations of the vanes 15 act as vortex generators, creating a multitude of vortices along each sub-stream. These vortices are of a very small size, and entrain fine pollutant particles in the gas stream.

The vortex patterns generated by the vanes 15 are believed to include a transverse eddying motion, aligned parallel to the vanes, whose dimensions are dependent upon the vane spacing, the vane length and the vane width, and a series of counter-rotating vortex structures whose dimensions are dependent upon the teeth 16 of the vanes. The flow velocity around the vanes 15 is believed to be substantially less than the mean flow velocity.

Although the zone of micro turbulence is limited to the centre of each passage, the macro turbulence in each substream ensures that the substream passes through this zone so that the particles in the substream are subjected to turbulence at particle scale. Moreover, by limiting the small scale turbulence to the centre region of each passage, the overall pressure drop through the agglomerator is minimised.

The foregoing describes only one embodiment of the invention, and modifications which are obvious to those skilled in the art may be made thereto without departing from the scope of the invention as defined in the accompanying claims. For example, although the invention has been described with particular reference to the mixing of particles in a gas stream, it also has application to mixing in other fluid flows, e.g. liquids.

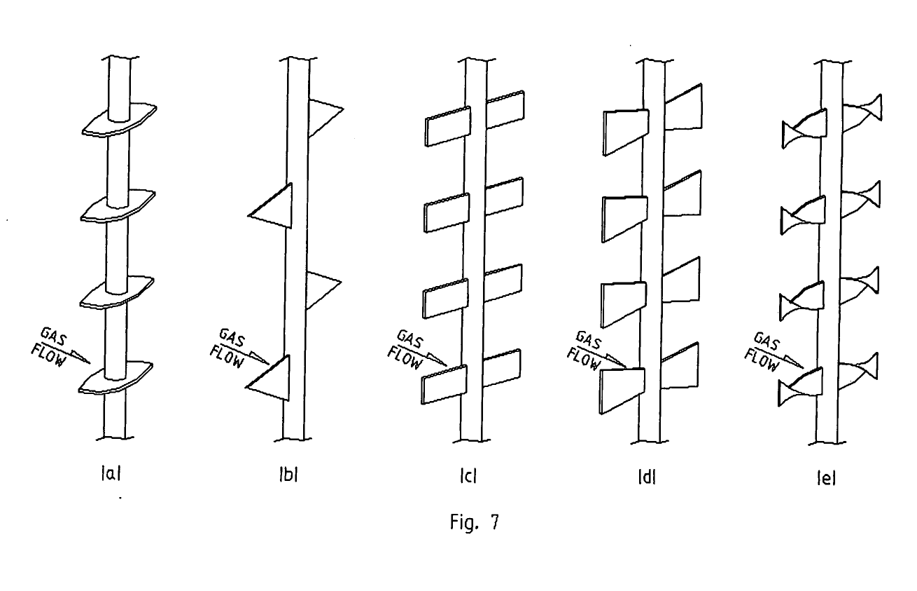

Furthermore, the shape and configuration of the vanes can be varied. FIGS. 7(a) to (e) illustrate alternative forms of vanes which may be used in the illustrated agglomerator.

Although the vanes 15 are preferably provided with teeth 16 to intensify the micro turbulence and focus it in the region immediately downstream of the vane, they are not essential to its creation. The zone of small scale turbulence can be generated by any suitably shaped vane (e.g. rods, bars, fins, etc), and will be concentrated between successive vanes if the vanes are aligned one behind the other in the wake of the preceding vane and are spaced so that the wake can fully form between successive vanes.

1. A method of promoting mixing of substances in a fluid stream, comprising the steps of
generating large scale turbulence in the fluid stream;
dividing the fluid stream into a plurality of substreams;
providing a formation in each substream to create a zone of small scale turbulence in the vicinity of the formation; and
causing each substream to pass through its respective zone of small scale turbulence so that it subjected to the small scale turbulence.

2. A method as claimed in claim 1, wherein each formation is located centrally relative to its respective substream.

3. A method as claimed in claim 2, wherein the formation comprises a plurality of spaced vanes arranged successively in a plane extending in the overall direction of flow of the fluid stream, the vanes being spaced close enough to provide a continuous zone of small scale turbulence.

4. A method as claimed in claim 1, wherein the fluid stream is an exhaust gas flow from an industrial process, and the substances include pollutant particles.

5. A method as claimed in claim 4, wherein the substances include particles added to the fluid stream to agglomerate with the pollutant particles.

6. A method as claimed in claim 1, when the step of dividing the stream into a plurality of substreams comprises directing the stream into a plurality of passages such that each substream flows through a respective passage.

7. Apparatus for promoting mixing of substances in a fluid stream, comprising
a conduit for the fluid stream;
a plurality of passages in the conduit for dividing the fluid stream into substreams flowing through respective said passages;
means for generating large scale turbulence in the fluid stream upstream from the plurality of passages; and
a formation in each passage for generating a zone of small scale turbulence in the vicinity of the formation;
wherein in use, the large scale turbulence causes the substream in each passage to pass through the zone of small scale turbulence.

8. Apparatus as claimed in claim 7, wherein each formation is located centrally relative to its respective passage, and its generated zone of small scale turbulence is located in the vicinity of the formation.

9. Apparatus as claimed in claim 8, wherein each formation comprises a plurality of spaced vanes arranged successively in a plane extending in the overall direction of flow of the fluid stream.

10. Apparatus as claimed in claim 9, wherein the vanes of the formation in each passage are mounted in a generally planar frame, the frame being located substantially centrally relative to the passage and extending in the overall direction of flow of the fluid stream.

11. Apparatus as claimed in claim 9, wherein each vane is an elongate member having sharp edge portions angled obliquely to the overall direction of flow of the fluid stream.

12. Apparatus as claimed in claim 11, wherein each vane has a toothed edge portion.

13. Apparatus as claimed in claim 7, further comprising a plurality of parallel, generally planar, members extending in the overall direction of flow of the fluid stream, and spaced transversely across the conduit, the passages being defined between adjacent pairs of the planar members.

14. Apparatus as claimed in claim 7, further comprising additional formations in the conduit upstream of the passages for promoting large scale turbulence in the fluid stream.

15. Apparatus as claimed in claim 7, wherein the conduit is an air duct, the fluid stream is an exhaust gas flow from an industrial process, and the substances include pollutant particles.

16. A non-energised aerodynamic agglomerator for promoting mixing and agglomeration of pollutant particles in a gas stream, the agglomerator comprising
a duct for receiving the gas stream;
a plurality of parallel, generally planar, members mounted in the duct, the planar members extending in the overall direction of flow of the gas stream, and being spaced transversely across substantially the whole width of the duct, each adjacent pair of the planar members defining a passage between them;
the duct being configured and/or having flow altering members therein for promoting large scale turbulence in the gas stream upstream of the passages;
a formation in each passage for generating a zone of small scale turbulence of such size and/or intensity that the pollutant particles are entrained in the turbulence, each formation being located centrally relative to its respective passage and comprising a plurality of spaced sharp-edged vanes arranged successively in a plane extending in the overall direction of flow of the gas stream;
wherein in use, the gas stream is divided into a plurality of substreams flowing through the respective passages, and the large scale turbulence in the substreams causes each substream to pass through the zone of small scale turbulence its respective passage so that particles therein are subjected to the small scale turbulence.
